(19) United States
(12) Patent Application Publication
(10) Pub. No.: US 2008/0043998 A1
(43) Pub. Date: Feb. 21, 2008

(54) Line interface for telephone

(75) Inventor: Richard W. Ulmer, Gilbert, AZ (US)

Correspondence Address: Paul F. Wille, 6407 East Clinton St., Scottsdale, AZ, 85254, US

(73) Assignee: Acoustic Technologies, Inc., Mesa, AZ (US)

(21) Appl. No.: 11/497,928

(22) Filed: Aug. 1, 2006

(51) Int. Cl. H04M 9/00; H04M 1/00

(52) U.S. Cl. 379/402

(57) ABSTRACT

A line interface includes a transmit path for an electrical signal, a receive path for an electrical signal, and a reference path coupled from the output of the transmit path to the receive path. The reference path including a filter for matching the impedance of the telephone line. The transmit path has an output coupled to the primary winding of a transformer. The secondary winding of the transformer is adapted to be coupled to a telephone line. The receive path has an input coupled to the primary winding and the reference path includes means for inverting an electrical signal, thereby providing a hybrid coupling function.

This invention relates to an interface circuit that couples a telephone to a central station by way of telephone lines and, in particular, to a circuit that optimizes the coupling regardless of the impedance of the telephone lines.

As known in the vernacular, and in the art, a “land line” refers to a wire connecting a telephone to a private branch exchange (PBX) or to a switching station. Typically, a land line is a pair of wires twisted about one another. The impedance of such a line is typically assumed to be six hundred ohms and resistive (I.e., neither capacitve nor inductive). Unfortunately, this is rarely the case. At the very least, the situation is complicated by the fact that the length of the line can be anywhere from one hundred feet to tens of thousands of feet.

The impedance of a telephone line is essentially one element of a voltage divider through which an outgoing signal and an incoming signal pass. Line length strongly affects impedance and it is desirable to have an interface that works well with lines of different lengths.

Matching the impedance of a telephone line is a problem long recognized in the art. U.S. Pat. No. 3,745,261 (Friedman) proposes to solve the problem by interpreting diminishing line current as an indication of line length and adjusting the gain of an amplifier accordingly. Line length is not the only factor that affects the impedance of a twisted pair.

U.S. Pat. No. 5,187,742 (Moran, III et al.) discloses a line interface for a modem in which the line interface includes selectable impedances to compensate for line length and a high pass filter in the receive circuit to compensate for low pass filter effects on the line and in the hybrid transformer.

Impedance not only affects amplitude and phase but also causes echo. An impedance mismatch causes electronic echo on a telephone line by reflecting some of a signal back to the source. Thus, impedance matching also helps to reduce the problem of echo cancellation by other parts of the system, either in a telephone or at the switching station. Although some sidetone is desirable, so there is not silence in the earpiece, it is desirable to minimize sidetone to reduce echoes.

Balancing an interface to a line can be a tedious process, depending upon the design of the interface, Generally, the more complicated the matching circuitry, the more difficult the adjustment. Further, the dependency of one stage on another complicates adjustment. For example, adjusting the gain of the transmit circuit usually requires adjustment of the gain of the receive circuit. Similar problems arise adjusting frequency response and phase.

In view of the foregoing, it is therefore an object of the invention to provide a line interface that works well with line lengths from hundreds of feet to thousands of feet without adjustment other than initial adjustment.

Another object of the invention is to provide a line interface that minimizes interdependency among portions of the interface.

A further object is to provide an interface that is easily adjusted.

### SUMMARY OF THE INVENTION

The foregoing objects are achieved in this invention in which a line interface includes a transmit path for an electrical signal, a receive path for an electrical signal, and a reference path coupled from the output of the transmit path to the receive path. The reference path including a filter for matching the impedance of the telephone line. The transmit path has an output coupled to the primary winding of a transformer. The secondary winding of the transformer is adapted to be coupled to a telephone line. The receive path has an input coupled to the primary winding and the reference path includes means for inverting an electrical signal, thereby providing a hybrid coupling function.

### BRIEF DESCRIPTION OF THE DRAWINGS

A more complete understanding of the invention can be obtained by considering the following detailed description in conjunction with the accompanying drawings, in which:

FIG. 1 is a perspective view of a desk telephone;

FIG. 2 is a perspective view of a cordless telephone;

FIG. 3 is a perspective view of a conference phone or a speaker phone;

FIG. 4 is a block diagram of audio processing circuitry in a telephone;

FIG. 5 is a block diagram of a line interface;

FIG. 6 is a block diagram of a hybrid network from a line interface;

FIG. 7 is a schematic diagram of the transmit section of a hybrid network constructed in accordance with a preferred embodiment of the invention; and

FIG. 8 is a schematic diagram of the receive section of a hybrid network constructed in accordance with a preferred embodiment of the invention.

Those of skill in the art recognize that, once an analog signal is converted to digital form, all subsequent operations can take place in one or more suitably programmed microprocessors. Reference to “signal”, for example, does not necessarily mean a hardware implementation or an analog signal. Data in memory, even a single bit, can be a signal. In other words, a block diagram can be interpreted as hardware, software, e.g. a flow chart, or a mixture of hardware and software. Programming a microprocessor is well within the ability of those of ordinary skill in the art, either individually or in groups.

### DETAILED DESCRIPTION OF THE INVENTION

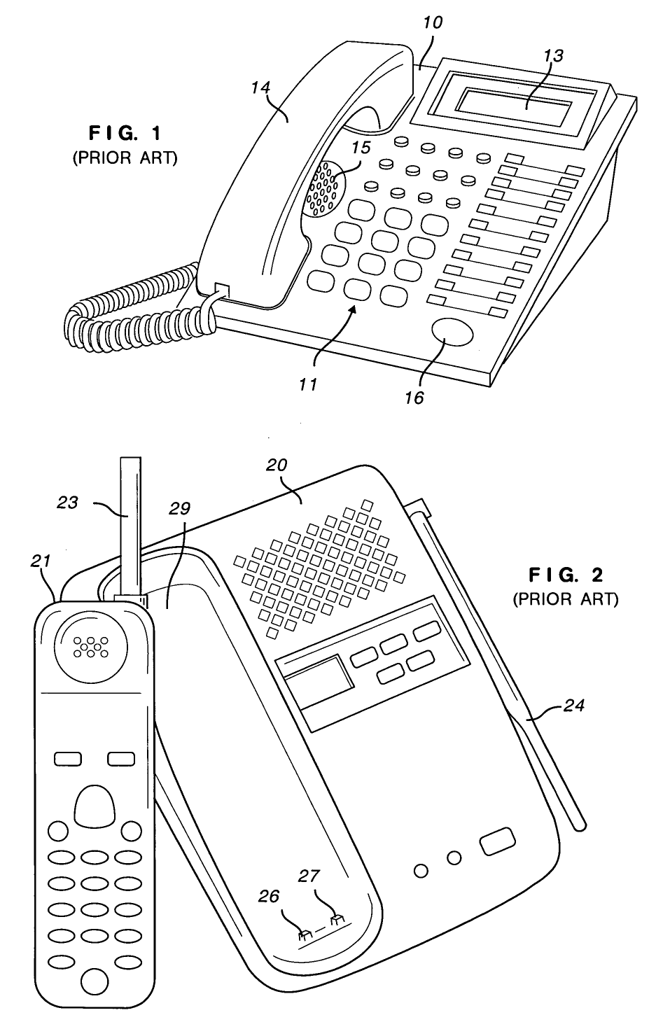

This invention finds use in many applications where the electronics is essentially the same but the external appearance of the device may vary. FIG. 1 illustrates a desk telephone including base 10, keypad 11, display 13 and handset 14. As illustrated in FIG. 1, the telephone has speaker phone capability including speaker 15 and microphone 16. The cordless telephone illustrated in FIG. 2 is similar except that base 20 and handset 21 are coupled by radio frequency signals, instead of a cord, through antennas 23 and 24. Power for handset 21 is supplied by internal batteries (not shown) charged through terminals 26 and 27 in base 20 when the handset rests in cradle 29.

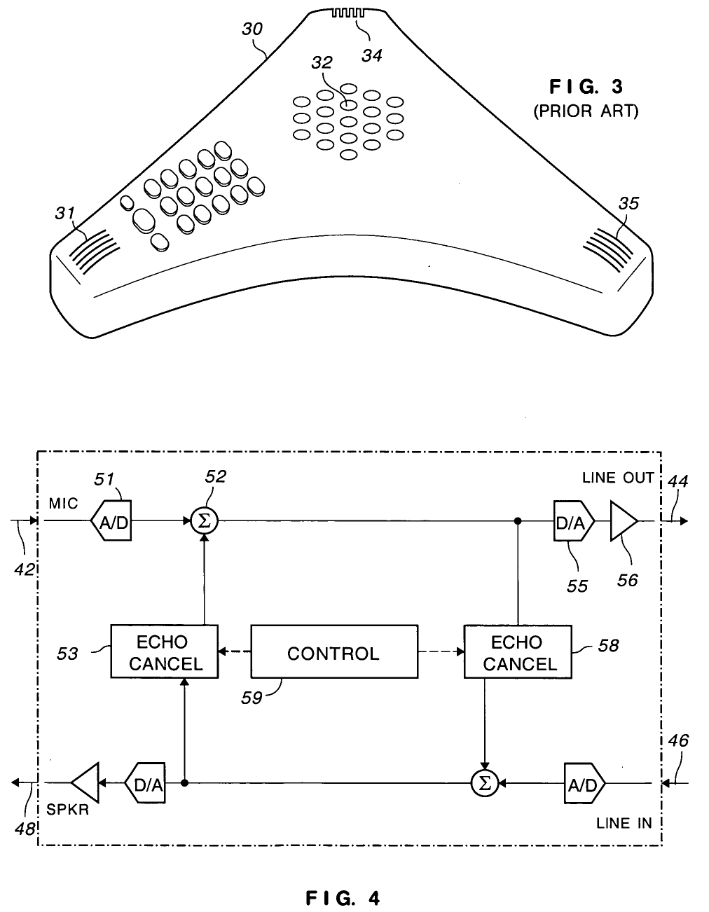

FIG. 3 illustrates a conference phone or speaker phone such as found in business offices. Telephone 30 includes microphone 31 and speaker 32 in a sculptured case. Telephone 30 may include several microphones, such as microphones 34 and 35 to improve voice reception or to provide several inputs for echo rejection or noise rejection, as disclosed in U.S. Pat. No. 5,138,651 (Sudo).

FIG. 4 is a detailed block diagram of a signal processing circuit; e.g. see chapter 6 of Digital Signal Processing in Telecommunications by Shenoi, Prentice-Hall, 1995. The following describes signal flow through the transmit channel, from microphone input 42 to line output 44. The receive channel, from line input 46 to speaker output 48, works in the same way, except that the gain of a particular stage may be different from the gain of a corresponding stage in the transmit channel.

New vocal sounds entering a microphone (not shown in FIG. 4) may or may not be accompanied by sounds from speaker output 48 or other sources. The analog signal on input 42 is digitized in A/D converter 51 and coupled to summation network 52. There is, as yet, no signal from echo canceling circuit 53 and the signal is then converted back to analog form by D/A converter 55, amplified in amplifier 56, and coupled to line output 44. Circuit 53 reduces acoustic echo and circuit 58 reduces line echo. The operation of these last two circuits is known per se in the art; e.g. as described in the above-identified text, and is controlled by control circuit 59.

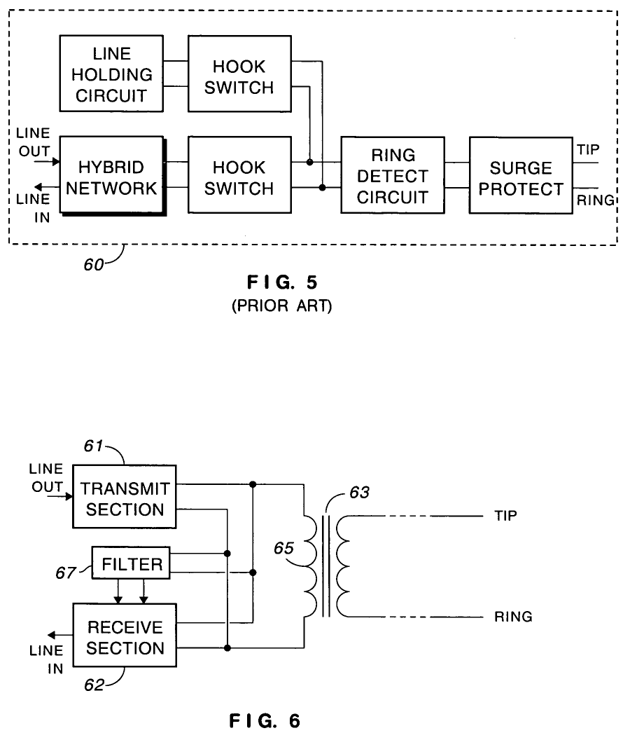

As illustrated in FIG. 5, line interface contains several circuits, typically including surge protection, ring detection, hook switching, and a hybrid network. The surge protection circuitry usually contains a surge suppresser or spark-gap as well as some resistors or fuses placed in series with the TIP and RING lines. This circuitry protects the telephone from lightning strikes and other high voltage surges on the TIP and RING lines. Any component that crosses from the network side of the interface (the part connected to the telephone lines) to the telephone side of the interface (the part connected to the telephone) must be able to withstand high voltage.

A ring detection circuit detects the ring pulses from a central office between the TIP and RING lines and provides a suitable signal to a microcontroller in the telephone indicating an incoming call.

A hook switch controls the on-hook and off-hook conditions for the telephone by way of signals to the microcontroller. The hook switch can be either a mechanical relay or a solid-state relay. The relay must be able to withstand high voltage because it is on the network side of the circuit.

A hybrid network can also be called an anti-sidetone circuit, induction coil, or terminating set. A hybrid network provides at least two functions, as illustrated in FIG. 6. A first function is to isolate the network side from the telephone side of the interface. A second function is to couple the transmit (or line out) and receive (or line in) wire pairs onto the two-wire local subscriber loop of a telephone network. To this end, the hybrid network illustrated in FIG. 6 includes transmit section 61 and receive section 62 connected in parallel to the primary winding of transformer 63. The secondary of transformer 63 is coupled to the TIP and RING lines of a telephone network.

Filter 67 is coupled between the output of transmit section 61 and receive section 6 unlike the prior art, which uses a signal internal to the transmit section as a reference signal. This configuration minimizes processing of signals in the receive section and in the transmit section and reduces phase distortion. This configuration also makes signal cancellation independent of transmit gain because both the transmitted signal and the reference (filtered) signal are from the output of transmit section 61.

An important metric for hybrid networks is Trans Hybrid Loss (THL). Trans Hybrid Loss is the ratio of the amplitude of the signal returned to the receiver to the amplitude of the signal sent from the transmitter. Any of the transmit signal that is coupled to the receive side can be heard as sidetone (no perceived delay) or network echo (perceived delay). This is usually not as noticeable on a handset as it is on a speakerphone. THL is preferably −12 dB or less (higher number) across the telephone frequency band as seen by the transmit and receive VADs (voice activity detectors). The flatter the THL is across frequency the better the performance of the telephone. The impedance of the subscriber loop affects THL. The more closely a hybrid network matches the impedance of the subscriber loop, the lower THL will be.

A subscriber loop can be any length and, therefore, almost any impedance. The matching of the impedance is done through a balancing network. Because the loop's impedance changes with line length, it is impossible to match all impedances exactly and a compromise impedance value must be chosen. For the telephone networks in the United States, this impedance is usually 600 ohms. When measuring THL, the measurements should be made on various line lengths to insure the THL requirements are met under all conditions that a telephone will be operating.

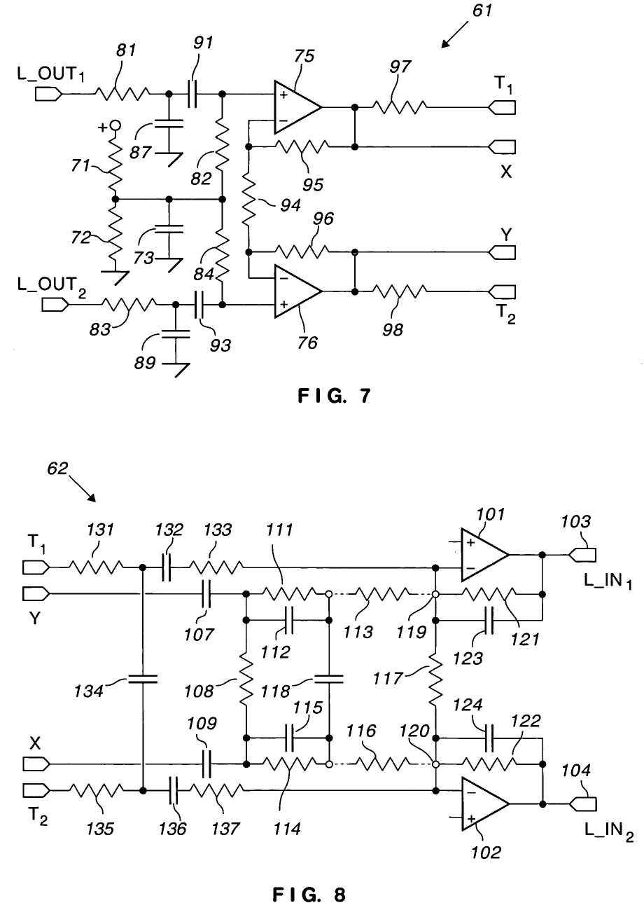

The transmit section of a hybrid network constructed in accordance with a preferred embodiment of the invention is illustrated in FIG. 7. Transmit section 61 buffers and amplifies the differential LINE OUT signal to drive the transformer to the telephone line. Although LINE OUT and LINE IN are shown in FIG. 4 as single lines, they are preferably actually implemented as differential lines or signal paths (one line carries the inverse of the signal on the other line) to improve resistance to noise and to interference.

A bias source including series resistors 71, 72 and capacitor 73 provides a bias voltage to differential amplifiers 75 and 76 to set the common mode of the amplifiers. The bias voltage is approximately one half the supply voltage, which, in one embodiment of the invention, was five volts. The L_{—}OUT₁ and L_{—}OUT₂ inputs come from LINE OUT 44 (FIG. 4). Resistors 81 and 82 are a voltage divider that causes a 6 dB loss (input signal divided by two). Resistors 83 and 84 are a voltage divider that causes a 6 dB loss.

Resistor 81 and capacitor 87 are a low pass filter pole at 10.6 kHz to roll off out-of-band signals. Resistor 83 and capacitor 89 are a low pass filter pole at 10.6 kHz to roll off out-of-band signals.

Capacitor 91 and resistor 82 are a high pass filter pole at about 100 Hz to roll off out of band signals. Capacitor 93 and resistor 84 are a high pass filter pole at about 100 Hz to roll off out of band signals.

The signal is rolled off at each edge of the bandwidth of the system to better match the bandwidth of the telephone line. In accordance with one aspect of the invention, the rolloff also prevents a signal from accruing significant gain out of band during subtraction in the hybrid circuit, thereby reducing distortion and power consumption in the circuit.

The gain of amplifier 75 is equal to (1+R₉₅)/(R₉₄/2). The gain of amplifier 76 is equal to (1+R₉₆)/(R₉₄/2). The provides the advantage that gain can be adjusted by changing the resistance of a single resistor (resistor 94). A disadvantage of the circuit is that the input is from a voltage divider, which necessarily reduces the input signal. In one embodiment of the invention, the gains of amplifiers 75 and 76 are approximately equal to four (12 dB). Thus, the overall gain of the transmit section from input L_{—}OUT₁ to output X, and input L_{—}OUT₂ to output Y, is approximately equal to two (6 dB).

Resistor 97, resistor 98, and the impedance of the primary winding 65 (FIG. 6) form a 600 ohm termination for transformer 63. The output of transmit section 61 (FIG. 7) looks like a 600 ohm termination to ground to a received signal.

Transmit section 61 (FIG. 6) and receive section 62 are coupled to primary winding 65. A received signal is coupled through transformer 63 from the TIP and RING lines to differential amplifiers 101 and 102 (FIG. 8) through filters. Outputs 103 and 104 are AC coupled into LINE IN input(s) 46 of the audio processing circuit illustrated in FIG. 4.

Resistor 131 and capacitor 134 are a low pass filter pole at 8.4 kHz to roll off out-of-band signals. Resistor 135 and capacitor 134 are also a low pass filter pole at 8.4 kHz to roll off out-of-band signals.

Capacitor 132 and resistor 133 are a high pass filter pole at about 70 Hz to roll off out of band signals. Capacitor 136 and resistor 137 are also a high pass filter pole at about 70 Hz to roll off out of band signals.

The high pass filters and the low pass filters in the transmit circuit and in the receive circuit, in a sense, remove components that should not be there in the first place. They do not substantially affect signals of interest passing through the filters. Most of the filtering is done in the reference signal path between the transmit section and the receive section. This is the path to the right of the Y and X inputs in FIG. 8.

Note that the X and Y outputs from transmit section 61 (FIG. 7) are paired oppositely with T₁ and T₂ as inputs to receive section 62 in FIG. 8. By using differential signal paths, opposite pairing provides a simple way to invert the reference signals. Inverting amplifiers could be used instead.

A signal on the Y input is filtered by a high pass filter, including capacitor 107 and resistor 108, having a pole at 25 Hz. The signal is then filtered by a low pass filter, including resistor 111 and capacitor 118, having a pole at 3.7 kHz. The filtered signal is coupled to the inverting input of amplifier 101 by resistor 113. The non-inverting (+) inputs of amplifiers 101 and 102 are coupled to a source of bias voltage, which provides a virtual ground, like the one shown in FIG. 7 but omitted for simplicity from FIG. 8. A signal on the X input is filtered in the same manner as the signal on the Y input and the filtered X signal is coupled to the inverting input of amplifier 102 by resistor 116.

The output of amplifier 101 is coupled to first summation node 119 by parallel resistor 121 and capacitor 123, thereby providing a low pass pole at 5.2 kHz. The output of amplifier 102 is coupled to second summation node 120 by parallel resistor 122 and capacitor 124, also providing a low pass pole at 5.2 kHz. The output of amplifier 101 is L_IN₁, node 103. The output of amplifier 102 is L_IN₂, node 104. The feedback provides some shaping of the band-limited signal from the cross-over or from the transmit circuit.

In accordance with another aspect of the invention, resistor 111 and capacitor 112 are a high pass filter having a zero at 8 kHz. Likewise, resistor 114 and capacitor 115 are a high pass filter having a zero at 8 kHz. These filters provide a slight pre-emphasis to compensate for the frequency response of the telephone lines. Again, the filtering takes place in the reference signal path, not the transmit path or the receive path.

The respective filters are not entirely independent due to loading effects but, as a first approximation, they function as described.

In one embodiment of the invention, the gains of amplifiers 101 and 102 are approximately equal to 1.34 (˜2.5 dB). The overall receive gain from TIP and RING to outputs 103 and 104 is approximately 0.912 or −0.8 dB, including the insertion loss of transformer 63.

Because the signal on Y is substantially the same as the signal on X, but inverted, the signals from inputs T₁ and Y subtract at first summation node 119 and the signals from inputs T₂ and X subtract at second summation node 120. This provides the hybrid coupling function. That is, a signal on T₁ is canceled if the same signal is on input Y. Conversely, a signal coupled from the secondary of transformer 63 (FIG. 6) to the primary is unaffected because it is not part of the signals on the X and Y inputs. A hybrid network constructed in accordance with the invention typically has a transmit rejection (Trans Hybrid Loss) of about −14.5 dB at 1 kHz from TIP and RING to LINE IN over line lengths of one thousand feet to sixteen thousand feet.

A hybrid constructed in accordance with the invention is preferably adjusted by shorting outputs T₁ and T₂, either to ground or to each other. Resistors 97 and 98 isolate the short from outputs X and Y. Now, only the reference signal appears at the receive output of the hybrid. A sweep frequency is applied to the transmit section and the response at the receive output (L_{—}IN) is noted. The short is removed and the reference paths are opened by removing resistors 113 and 116 from the circuit (electrically, e.g. by opening a switch (not shown), not physically). A sweep frequency is again applied to the transmit section and the response at the receive output is noted. By comparing the two responses, the reference path filters are adjusted until the receive output appears substantially the same under both conditions. This method adjusts the hybrid for maximum Trans Hybrid Loss without affecting the gain in the transmit section or the receive section.

Although the values of individual components can vary considerably depending upon application, supply voltage, and active devices, the following values were found suitable for a circuit having a five volt supply voltage and the operational amplifiers listed.

| element | value | |
|---|---|---|
| 71 | 10 | kΩ |
| 72 | 10 | kΩ |
| 73 | 0.1 | μf |
| 75 | OPA2340UA | |
| 76 | OPA2340UA | |
| 81 | 100 | kΩ |
| 82 | 100 | kΩ |
| 83 | 100 | kΩ |
| 84 | 100 | kΩ |
| 87 | 150 | pf |
| 89 | 150 | pf |
| 91 | 15 | nf |
| 93 | 15 | nf |
| 94 | 33.2 | kΩ |
| 95 | 49.9 | kΩ |
| 96 | 49.9 | kΩ |
| 97 | 267 | Ω |
| 98 | 267 | Ω |
| 101 | OPA2340UA | |
| 102 | OPA2340UA | |
| 107 | 330 | nf |
| 108 | 39 | kΩ |
| 109 | 330 | nf |
| 111 | 49.9 | kΩ |
| 112 | 390 | pf |
| 113 | 100 | kΩ |
| 114 | 49.9 | kΩ |
| 115 | 390 | pf |
| 116 | 100 | kΩ |
| 117 | 100 | kΩ |
| 118 | 430 | pf |
| 121 | 127 | kΩ |
| 122 | 127 | kΩ |
| 123 | 240 | pf |
| 124 | 240 | pf |
| 125 | 200 | Ω |
| 126 | 200 | Ω |
| 131 | 47.5 | kΩ |
| 132 | 47 | nf |
| 133 | 47.5 | kΩ |
| 134 | 200 | pf |
| 135 | 47.5 | kΩ |
| 136 | 47 | nf |
| 137 | 47.5 | kΩ |

The invention thus provides a telephone line interface that works well with line lengths from hundreds of feet to thousands of feet and that minimizes sidetone.

Having thus described the invention, it will be apparent to those of skill in the art that various modifications can be made within the scope of the invention. For example, the number of poles in the filters can be changed. Resistors can be passive devices or active devices. De-coupling resistors can be added to the T₁ and T₂ outputs of the transmit section. The roll-off frequencies and other values given above are by way of example only and not to be construed as limitations. The simplest way to invert the X and Y lines is simply to cross them as shown. One could also invert the signals digitally (as data) or with an active device (as analog signals). The rolloff or corner frequencies of the high pass filters and the low pass filters are approximate can be adjusted as desired for a particular application. For telephones, a bandwidth of 300-3,300 Hz is minimal. The wider bandwidth described above is preferred. In the reference path, it does not matter whether one inverts and then filters or filters and then inverts. Similarly, whether one uses a high pass filter and then a low pass filter or a low pass filter and then a high pass filter, the end result is the same, although component values will probably be different.

What is claimed as the invention is:

1. A hybrid circuit including a transformer having a primary winding and a secondary winding, wherein the secondary winding can be coupled to a telephone line, said hybrid circuit further comprising:
a transmit path for an electrical signal, said transmit path having an output coupled to the primary winding;
a receive path for an electrical signal, said receive path having an input coupled to the primary winding;
a reference path having an input coupled to the output of the transmit path and an input coupled to the input of the receive path, said reference path including a filter for matching the impedance of the telephone line.

2. The hybrid circuit as set forth in claim 1 wherein said reference path includes means for inverting an electrical signal.

3. The hybrid circuit as set forth in claim 2 wherein the transmit path and the receive path each include differential signal paths.

4. The hybrid circuit as set forth in claim 3 wherein said means includes a cross-over between the differential signal paths.

5. A line interface including a hybrid network for coupling a telephone having lINE IN and LINE OUT leads to a telephone line including at least a pair of wires, wherein said hybrid network comprises:
a transformer having a primary winding and a secondary winding, wherein the secondary winding can be coupled to said telephone line;
a first amplifier having a first input coupled to a LINE OUT lead and an output coupled to said primary winding;
a second amplifier having a first input coupled to a LINE IN lead and an output coupled to said primary winding;
a filter circuit;
means for inverting a signal coupling the filter circuit to the first input of the second amplifier;
wherein a signal from said first amplifier is subtracted from a signal on the first input of said second amplifier; and
wherein said filter circuit substantially matches the impedance of the telephone line to the telephone.

6. The line interface as set forth in claim 5 wherein the filter circuit includes a high pass filter and a low pass filter coupled in series.

7. The line interface as set forth in claim 5 wherein the filter circuit includes a pre-emphasis circuit.

8. The line interface as set forth in claim 5 wherein said filter circuit includes means for inverting an electrical signal.

9. The line interface as set forth in claim 5 wherein said interface is implemented with differential signal paths.

10. The line interface as set forth in claim 9 wherein said filter circuit includes a cross-over between the differential signal paths.
